(19) United States
(12) Patent Application Publication
(10) Pub. No.: US 2012/0211134 A1
(43) Pub. Date: Aug. 23, 2012

(54) Handbag with Removable Liner

(75) Inventor: Kathryn Marlene Goldstein, Chicago, IL (US)

(73) Assignee: Barbara Goldstein, Highland Park, IL (US)

(21) Appl. No.: 13/403,387

(22) Filed: Feb. 23, 2012

Related U.S. Application Data
(60) Provisional application No. 61/445,612, filed on Feb. 23, 2011.

(51) Int. Cl. A45C 13/02; B29C 65/54; B23P 11/00; A45C 3/00; A45C 13/00

(52) U.S. Cl. 150/128; 150/129; 29/428; 29/402.08; 156/293

(57) ABSTRACT

A handbag includes a containment structure with a pair of opposed sidewalls, and a pair of opposed end walls. Each end wall is adjacent the pair of sidewalls and a lower wall interconnects the sidewalls and the end walls. The lower wall includes an upper inner surface. A liner is removably secured to the upper inner surface of the lower wall. The liner has a length and width to substantially cover the upper inner surface of the lower wall. A method of applying the liner is also provided.

### BACKGROUND

The present disclosure relates generally to handbags and, more particularly, to handbags having a removable liner along an inner surface thereof.

Handbags such as purses, backpacks, briefcases, sacks, totes, and the like are often used for carrying various articles on a day-to-day basis. Due to the frequency of use and the types of articles that are carried within the handbags, the inside surfaces of the handbags may often become significantly dirty or unsanitary. For example, purses are often used to carry various types of make-up and other similar products. After use, some make-up may remain on the outer surfaces of the make-up containers. In addition, the containers housing the make-up sometimes open accidently, spilling their contents within the purse. In either case, the inner surfaces of the purse may become coated with make-up residue.

In another example, backpacks are used to carry a wide variety of articles, often including thud such as lunches. Containers holding the thud may break open or otherwise spill food within the backpack. Food products within the backpack may result in unsanitary conditions On the inner surfaces of the backpack.

Dirty or unsanitary conditions within a handbag may result in the replacement of the handbag, even though the outer surfaces of the handbag remain in excellent condition. A solution to solve the deficiencies of the prior art would be desirable.

### SUMMARY

In one aspect, a handbag includes a containment structure with a pair of opposed sidewalls, and a pair of opposed end walls. Each end wall is adjacent the pair of sidewalls and a lower wall interconnects the sidewalls and the end walls. The lower wall includes an upper inner surface. A liner is removably secured to the upper inner surface of the lower wall. The liner has a length and width to substantially cover the upper inner surface of the lower wall.

In another aspect, a method of applying a removable liner to a handbag is provided. The handbag has a containment structure including sidewalls and end walls interconnected by a lower wall. The lower wall has an upper inner surface. The method includes providing a liner having a length and width to substantially cover the lower wall and securing the liner to the lower wall with a releasable medium.

### BRIEF DESCRIPTION OF THE SEVERAL VIEWS OF THE DRAWING(S)

Various other objects, features and attendant advantages will become more fully appreciated as the same become better understood when considered in conjunction with the accompanying drawings in which like reference numbers designate the same or similar parts throughout the several views, and in which:

FIG. 1 is a side elevational view of a handbag having a removable liner therein;

FIG. 2 is a top plan view of the handbag of FIG. 1;

FIG. 3 is a section taken generally along line 3-3 of FIG. 2;

FIG. 4 is an enlarged view of the encircled area 4 of FIG. 3;

FIG. 5 is an alternate embodiment of the encircled area of FIG. 4;

FIG. 6 is another alternate embodiment of the encircled area of FIG. 4; and

FIG. 7 is an alternate embodiment of a handbag having a removable liner therein.

### DETAILED DESCRIPTION OF THE ILLUSTRATED EMBODIMENTS

The following description is intended to convey the operation of exemplary embodiments of the invention to those skilled in the art. It will be appreciated that this description is intended to aid the reader, not to limit the invention. As such, references to a feature or aspect are intended to describe a feature or aspect of an embodiment, not to imply that every embodiment must have the described characteristic. Furthermore, it should be noted that the depicted detailed description illustrates a number of features. While certain features have been combined together to illustrate potential system designs, those features may also be used in other combinations not expressly disclosed. Thus, the depicted combinations are not intended to be limiting unless otherwise noted.

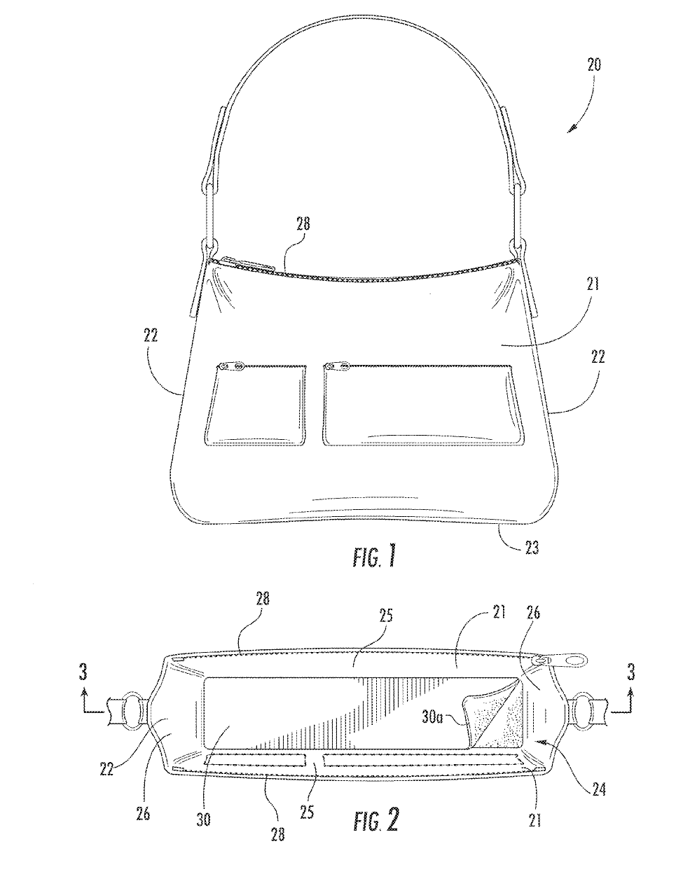

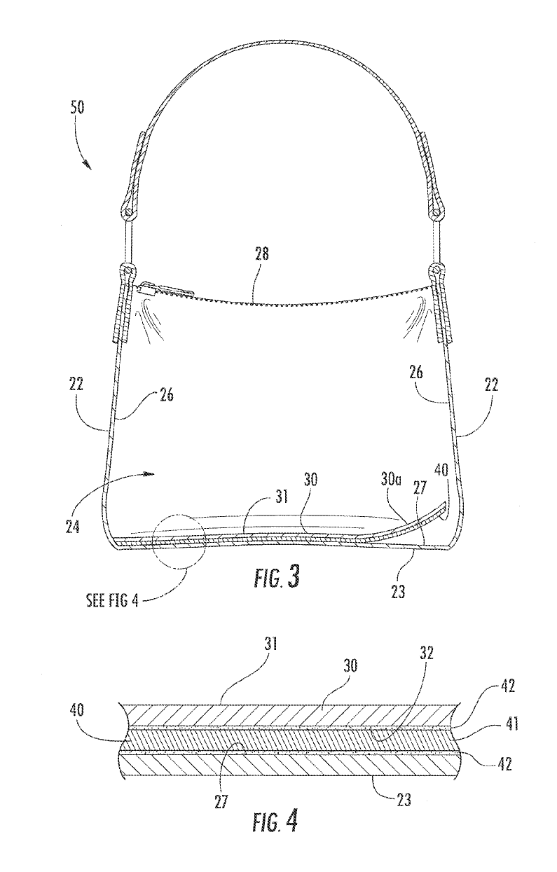

Referring to FIGS. 1-2, a handbag 20 such as a purse is depicted having a pair of spaced apart sidewalls 21, a pair of spaced apart end walls 22 connected to each sidewall, and a lower wall 23 connected to each of the sidewalls and the end walls in order to create a containment structure 24. More specifically, the inner surfaces of 25 of sidewalls 21, the inner surfaces of 26 of end walls 22 and the upper surface 27 of lower wall 23 define the vertical and bottom surfaces of the containment structure 24. As depicted, each sidewall 21 includes one half of a closure such as a zipper assembly 28 along its upper edge to permit closing the handbag 20 as desired. Other types of closures including buckles, overlapping flaps and the like may also be used or a closure may be omitted. Handbag 20 may be formed of a variety of materials including leather, fabric and plastics. As used herein, the term “handbag” may be any type of hand carried bag or container for transporting personal items and other similar materials including purses, backpacks, briefcases, sacks, totes, and the like.

It should be noted that in this description, representations of directions such as up, down, left, right, front, rear, and the like, used for explaining the structure and movement of each part of the disclosed embodiment are not intended to be absolute, but rather are relative. These representations are appropriate hen each part of the disclosed embodiment is in the position shown in the figures. If the position or frame of reference of the disclosed embodiment changes, however, these representations are to be changed according to the change in the position or frame of reference of the disclosed embodiment.

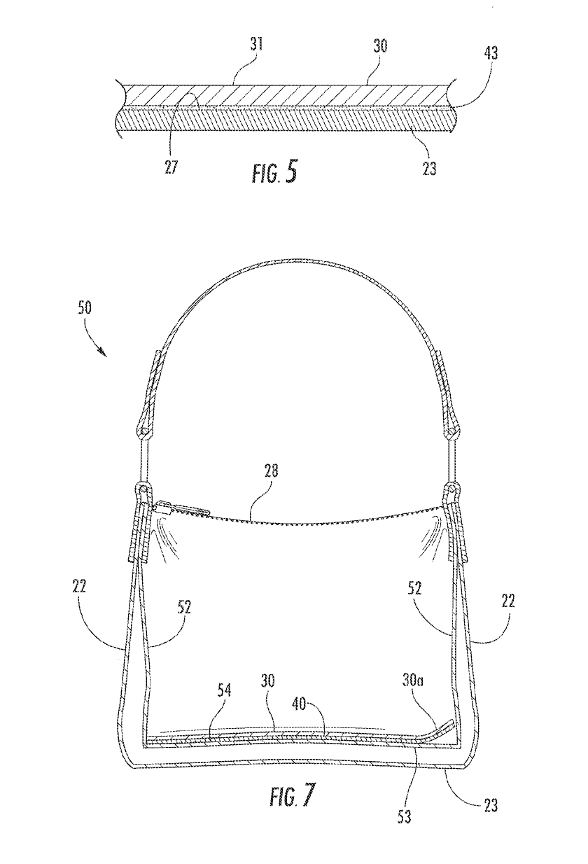

As best seen in FIGS. 3-4, a removable liner 30 is positioned along the upper surface 27 of lower wall 23. Liner 30 may be a generally planar, flexible sheet of material having a top surface 31 and bottom surface 32. Top surface 31 forms the bottom surface of the containment structure 24 when the liner 30 is positioned within handbag 20. Bottom surface 32 of liner 30 faces the upper surface 27 of lower wall 23 of handbag 20. Liner 30 may be formed of a variety of materials such as cotton, nylon, polyester, rayon, leather, silk, plastic, rubber or other materials with characteristics suitable for use as a liner of handbag 20. In some instances, it may be desirable to extend liner 30 beyond the lower surface 27 of lower wall 23 and up the inner surfaces 25 of sidewalls 21 and/or the inner surfaces 26 of end walls 22 to some extent. In still other instances, it may be desirable to extend line 30 along most or all of the inner surfaces 25 of the sidewalls 21 and/or the inner surfaces 26 of the end walls 22.

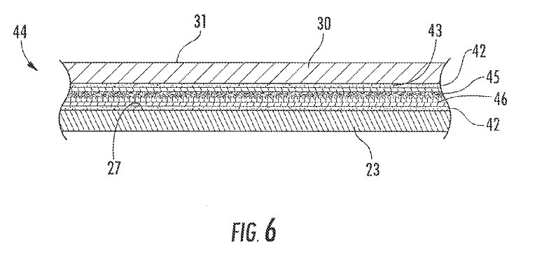

Liner 30 is depicted as being secured to the upper surface 27 lower wall 23 with a releasable medium. In one example such releasable medium may be an adhesive material such as two-sided tape 40. Tape 40 includes a flexible base or film material 41 and a pressure sensitive adhesive 42 on both sides of the tape. In an alternate embodiment, a single-sided tape may be substituted for the two-sided tape. The single-sided tape may be identical to that depicted in FIG. 4 but one of the layers of pressure sensitive adhesive 42 is replaced by a separately applied adhesive such as a glue. In such case, the non-adhesive side of the tape may be secured to the bottom surface 32 of the liner 30 and the pressure sensitive adhesive 42 used to secure the liner 30 to the upper surface 27 of lower wall 23. In an alternate embodiment depicted in FIG. 5, an adhesive 43 such as a glue may be applied directly to the bottom surface 32 of liner 30, the upper surface 27 of lower wall 23 or both surfaces. In the alternate embodiment depicted in FIG. 6, tape 40 and other adhesives may be replaced by a hook and loop fastener system 44 such as Velcro® with the hook half 45 of the fastener system secured to the upper surface 27 of lower wall 23 of handbag 20 and the loop half 46 of the fastener system secured to bottom surface 32 of liner 30. The hook and loop halves 45, 46 could be reversed and attached to the other of the lower wall 23 and liner 30 as desired.

It is desirable for liner 30 to be removable so that it may be replaced by another liner when desired by the user. Accordingly, the characteristics (e.g., strength, durability, etc.) of the bond and materials used to secure liner 30 to handbag 20 permit a semi-permanent or releasable mounting of the liner to the handbag. In other words, it is desirable for the liner 30 to be secured to the handbag so that it will not be removable unless desired by the owner of the handbag 20 yet permit removal without destruction of the handbag. In one example, a two-sided tape such 3M® Double Sided Removable Tape may be used. Such tape has a first side of adhesive that is permanent and a second side of adhesive that is removable. The first permanent side may be adhered to the bottom surface 32 of the liner 30 while the second removable side is adhered to the upper surface 27 of the lower wall 23. In other examples, a single-sided tape that is removable may have its non-adhesive side permanently mounted to the bottom surface 32 of liner 30 and the single-sided adhesive used to secure liner 30 to the upper surface 27 of the lower wall 23.

During assembly, liner 30 may be provided in a pre-cut manner to match the dimensions of the lower wall 23 of handbag 20 or may be cut to the desired dimensions from a relatively large sheet of material. If it is desired for the liner to extend along a portion of the inner surface 25 of the sidewalls 21 and/or the inner surface 26 of the end walls 23, the liner 30 may be dimensioned larger than the lower wall 23. In the alternative, after the liner 30 is applied to the lower wall 23, an additional portion of the liner may be applied to the inner surface 25 of the sidewalls 21 and/or the inner surface 26 of the end walls 23.

Tape 40 may be applied to the bottom surface 32 of the liner 30 either before or after the sizing operation. Once the liner has been dimensioned to match the lower wall 23, a backing material (not shown) is removed from tape 40 so as to expose the adhesive 42 facing awn from the bottom surface 32 of liner 30. In the alternative, tape 40 may be applied to the upper surface 27 of lower wall 23. It may be found that applying the adhesive to the upper surface 27 of lower wall 23 simplifies the installation of the liner 30 as it may reduce the likelihood that the liner will be secured to a sidewall 21 or end wall 22 during the alignment process. In either case, liner 30 is then aligned with bottom wall 23 and pressure applied to the liner to secure the liner 30 to the upper surface 27 of bottom wall 23. In some situations, it may be desirable to align an edge of liner 30 with an edge of bottom wall 23 and pressure applied at that edge. Alignment of liner 30 is then continued and pressure applied until the liner has been completely secured to bottom wall 23. Liner 30 is depicted in FIG. 3 during the process of applying the liner to the bottom wall 23 and with a portion 30a not yet secured to the bottom wall.

In instances in which the liner 30 has been sized to extend along either sidewalls 21 or end walls 22, tape 40 is also applied to liner 30 so as to extend along the sidewalls or end walls, as applicable. Once the liner has been secured to the bottom wall 23, the backing material may be removed from the portion of liner 30 along the sidewalls 21 or end walls 22 and pressure applied to the liner to secure it to the sidewalls or end walls.

In the alternate embodiment depicted in FIG. 7, the handbag 20 may include an inner lining 50 secured generally adjacent the upper region of the inner surfaces 25 of sidewalls 21 and inner surfaces 26 of end walls 22 that is not secured to the lower wall 23. The inner lining 50 includes a sidewall 51 adjacent each sidewall 21 of handbag 20, an end wall 52 adjacent each end wall 22 and a lower wall 53 generally adjacent lower wall 23. The sidewalls 51, the end walls 52 and the lower wall 53 are connected to form a containment structure 54. In such case, liner 30 is secured to the upper surface 55 of the lower wall 53. The inner lining 50 may be configured to be pulled out of the handbag while still attached to the sidewalls 21 and end walls 22 and thus may be removed from the handbag 20. Such removal of the inner lining 50 may simplify the process of applying the liner 30 to the upper surface 55 of lower wall 53 by increasing access to the lower wall 53. After application of the liner 30 to the lower wall 53 is completed, the inner lining 50 having the liner 30 may be returned to the handbag 20.

Although the disclosure provided has been described in terms of illustrated embodiments, it is to be understood that the disclosure is not to be interpreted as limiting. Various alterations and modifications will no doubt become apparent to those skilled in the art after having read the above disclosure. Numerous other embodiments, modifications and variations within the scope and spirit of the appended claims will occur to persons of ordinary skill in the art from a review of this disclosure.

1. A handbag comprising:
a containment structure, the containment structure having a pair of opposed sidewalls, a pair of opposed end walls, each end wall being adjacent the pair of sidewalls, and a lower wall interconnecting the sidewalls and the end walls, the lower wall including an upper inner surface; and
a liner removably secured to the upper inner surface of the lower wall, the liner having a length and width to substantially cover the upper inner surface of the lower wall.

2. The handbag of claim 1, wherein the liner is secured to the upper inner surface of the lower wall with a two-sided tape.

3. The handbag of claim 2, wherein the two-sided tape has a permanent adhesive on a first side that engages the liner and a removable adhesive on a second side engages the upper inner surface of the lower wall.

4. The handbag of claim 1, wherein the liner is secured to the upper inner surface of the lower wall with a single-sided tape.

5. The handbag of claim 4, wherein the single-sided tape has a releasable adhesive, the single-sided tape being permanently secured to the liner and the releasable adhesive engaging the upper inner surface of the lower wall.

6. The handbag of claim 1, wherein the liner is secured to the upper inner surface with a hook and loop fastener system.

7. A method of applying a removable liner to a handbag, comprising:
providing a handbag having a containment structure including sidewalls and end walls interconnected by a lower wall, the lower wall including an upper inner surface;
providing a liner having a length and width to substantially cover the lower wall; and
securing the liner to the lower wall with a releasable medium.

8. The method of claim 7, wherein the upper inner surface of the bottom wall has a length and width and further including trimming the liner to generally match the length and width of the upper inner surface.

9. The method of claim 7, further including providing a two-sided tape and securing the liner to the lower wall with the two-sided tape.

10. The method of claim 9, wherein the two-sided tape has a first side with a permanent adhesive and a second side with a releasable adhesive, and further including securing the first side of the tape to the liner with the permanent adhesive, and securing the second side of the tape to the upper inner surface of the lower wall with the releasable adhesive.

11. The method of claim 10, wherein the second side of the tape is secured to the upper inner surface of the lower wall before the first side of the tape is secured to the liner.

12. The method of claim 7, further including providing a single-sided tape and securing the liner to the lower wall with the single-sided tape.

13. The method of claim 12, wherein the single-sided tape has a first side and a second side, the second side having a releasable adhesive, and further including securing the first side of the tape to the liner with a permanent adhesive, and securing the second side of the tape to the upper inner surface of the lower wall with the releasable adhesive.

14. The method of claim 13, wherein the second side of the tape is secured to the upper inner surface of the lower wall before the first side of the tape is secured to the liner.

15. The method of claim 7, further including applying an adhesive to one of the upper inner surface of the lower wall and a surface of the liner.

16. The method of claim 7, further including removing the liner from the lower wall and providing a second liner having a length and width to substantially cover the lower wall, and securing the second liner to the lower wall with a releasable medium.

17. The method of claim 7, further including securing a first half of a hook and loop fastener system to the upper inner surface of the lower wall, securing a second half of the hook and fastener system to the liner, and securing the first half of the hook and fastener system to the second half of the hook and fastener system.

18. A handbag comprising:
a containment structure, the containment structure having a pair of opposed sidewalls, a pair of opposed end walls, each end wall being adjacent the pair of sidewalls, and a lower wall interconnecting the sidewalls and the end walls, the lower wall including an upper inner surface; and
a liner removably secured to the upper inner surface of the lower wall.

19. The handbag of claim 18, wherein the liner is secured to the upper inner surface of the lower wall with a two-sided tape.

20. The handbag of claim 18, wherein the liner is secured to the upper inner surface of the lower wall with a single-sided tape.
